(19) United States
(12) Patent Application Publication
(10) Pub. No.: US 2016/0318214 A1
(43) Pub. Date: Nov. 3, 2016

(54) METHOD FOR MANUFACTURING COMPOSITE PARTS

(71) Applicant: Airbus Operations S.L., Getafe (ES)

(72) Inventors: Ricardo PINILLOS MARTÍNEZ, Getafe (ES); Victor GARCÍA SOLARES, Getafe (ES); Pilar MUÑOZ LÓPEZ, Getafe (ES); Melania PÉREZ SÁNCHEZ, Getafe (ES)

(21) Appl. No.: 15/130,284

(22) Filed: Apr. 15, 2016

(30) Foreign Application Priority Data
Apr. 30, 2015 (EP) 15382219.2

(51) Int. Cl. B29C 35/02; B29C 35/16; B29B 11/00; B29C 33/04

(52) U.S. Cl. CPC B29C 35/02; B29C 33/04; B29C 35/16; B29B 11/00; B29K 2063/00

(57) ABSTRACT

Method for manufacturing composite parts, wherein at least a first composite part is joined to a second composite part, including providing the first composite part preform into a resin transfer mold, heating the first part into the resing transfer mold for performing a curing cycle of the first part, cooling the first part before the curing cycle is completed so that a semi-cured first part is obtained, and joining the semi-cured first part to a cured prepreg second part for obtaining the final composite part.

### CROSS-REFERENCE TO RELATED APPLICATION

This application claims the benefit of and priority to European patent application No. 15382219.2 filed on Apr. 30, 2015, the entire disclosure of which is incorporated by reference herein.

### TECHNICAL FIELD

The present disclosure refers to a method for manufacturing parts made of carbon fiber reinforced polymers.

### BACKGROUND

The following manufacturing methods for joining two composite parts are known in the state of the art.
Co-curing. Join between two fresh parts with chemical cross-linking.

Although this method produces a high quality join between the parts it has the drawback that for complex parts (high level of integration) is difficult to obtain a piece without defects as it works better when the join is simple.
Co-bonding. Join between fresh and cured part with chemical cross-linking plus adhesive join. This method has the drawback that it is difficult to control the thickness and the homogeneous distribution of the bonding line between the joined parts. Additionally, some bonding secondary and preparatory operations are necessary as, for instance, providing an adhesive layer to perform the join, the use of a release fabric to be peeled off before the adhesion and sometimes the surfaces need to be sanded and cleaned before bonding. As a consequence, the method implies high lead times and recurrent costs and a high number of steps have to be performed for achieving a quality join.
Secondary bonding. Join between two cured parts with adhesive join. It has the drawback that it is difficult to assure a homogeneous bonding line distribution, which leads to an unproper adhesive performance. Therefore, rivets are required after the join to prevent adhesive fails. Additionally, bonding secondary and preparatory operations are needed as, for instance, providing an adhesive layer and sometimes the surface ready to join need to be sanded before the bonding.

### SUMMARY

This disclosure herein relates to manufacturing composite complex parts with a method that achieves a reduction of the manufacturing steps and a reduction of riveted joins.

The claimed method is suitable for joining at least a first part and a second part and comprises:
providing a first part preform into a resin transfer mold;
heating the first part into the resing transfer mold for performing a curing cycle of the first part;
cooling the first part before the curing cycle is completed so that a semi-cured first part is obtained; and
joining the semi-cured first part to a cured prepreg second part for obtaining the final composite part.

The disclosure herein develops a new type of joining: cured composite parts combined with not fully cured parts. This joining combines the main features/advantages of co-curing and co-bonding method therefore increasing the quality of the manufacturing method.

The disclosure herein allows the manufacturing of not fully cured resin transfer molding parts (RTM) able to be post-cured and consolidated with traditional cured counterparts with the aim to produce one-shot integrated structures reducing cost and time. Ensuring an adequate degree of cure, the composite first part is able to adapt to the second composite part thickness variations maintaining the geometry without resin bleeding from the semi-cured part.

The joining between the semi-cured first part and the cured prepreg second part could be performed by a mechanical press or by pneumatics or hydraulics or in an autoclave. Additionally the joining between the semi-cured first part and the cured prepreg second part is performed by inserting a structural adhesive between both parts.

Advantages of the method of the disclosure herein include:
High control of the homogeneity and thickness of the bonding line, ensuring a proper mechanical performance of the adhesive joint. Chemical cross-linking as joining mechanism.
Avoiding bonding secondary and preparatory operations, for instance, adhesive layer lay-up or sanding. Implying high reduction on lead times and recurrent costs of several manufacturing processes.
Reducing or avoiding riveted joins.
High advantages regarding the storage conditions of the semi-cured part in comparison to un-cured parts.
High flexibility/adaptability to join parts with complex geometries without internal residual stress.

The semicured resin make the first part deformable at the temperature were prepregs are cured and, therefore, they exhibit the ability to adapt to geometrical changes of the second part such as thickness changes or to absorb dimensional tolerances.

Additionally, it is also an object of the disclosure herein a resin transfer mold that comprises a cavity for inserting a composite part preform wherein it further comprises a number of independent heat resistances and a cooling system that allow a detailed control of the temperature of the composite part during the curing cycle of the first part.

### BRIEF DESCRIPTION OF THE DRAWINGS

To complete the description and in order to provide for a better understanding of the disclosure herein, a set of drawings is provided. The drawings form an integral part of the description and illustrate preferred embodiments of the disclosure herein. The drawings comprise the following figures.

FIG. 1 shows a perspective view of a stringer joined to a skin, the stringer being the first composite part and the skin the second composite part.

FIG. 2 shows a cross-section of an embodiment of a mold of resin transfer molding.

FIG. 3 shows a schematic representation with the distribution of a heating resistance in a transversal section of the mold of FIG. 2.

FIG. 4 shows a schematic representation with the distribution of a cooling fluid flow in a transversal section of the mold of FIG. 2.

FIG. 5 shows a schematic representation of an embodiment disclosing the distribution of caul plates used in the join of the stringer and the skin of FIG. 1.

FIG. 6 shows a schematic representation of an embodiment disclosing the distribution of caul plates used in the join of the stringer and the skin of FIG. 1.

FIG. 7 shows a schematic representation of the join between a first composite part and a second composite part.

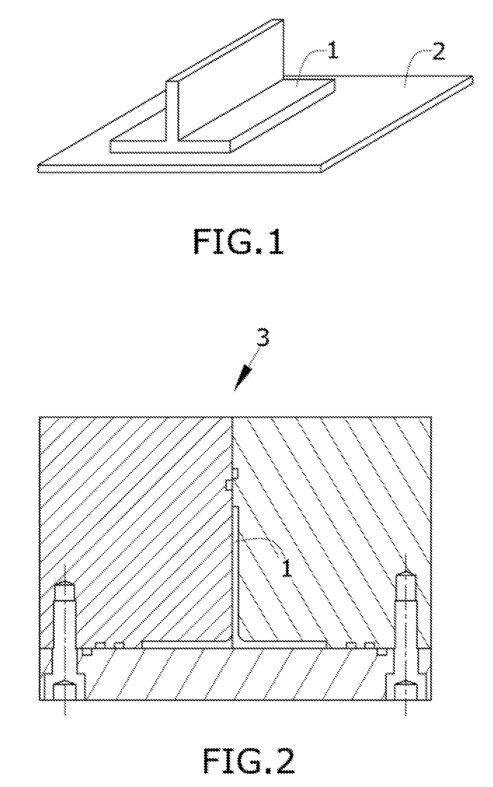

### DETAILED DESCRIPTION

There are several components that could be manufactured with the claimed method, for instance, stringer integration on wing, HTP and VTP covers, fuselage frames riveted or omega stringers integration on fuselage. The figures accompanying the description disclose a T-stringer (1) joined to a skin (2).

In the embodiment shown the semi-cured material is manufactured by using resin transfer molding from woven carbon fabrics and epoxy resin (RTM). The glass transition temperature (Tg) of the semi-cured part (1) should lie between two limits. On one hand, the glass transition temperature should be high enough to maintain tackiness and deformability of the first part (1) within acceptable. On the other hand, the glass transition temperature should be low enough to provide the semi-cured part (1) with the adaptability necessary for the subsequent post-cure cycle.

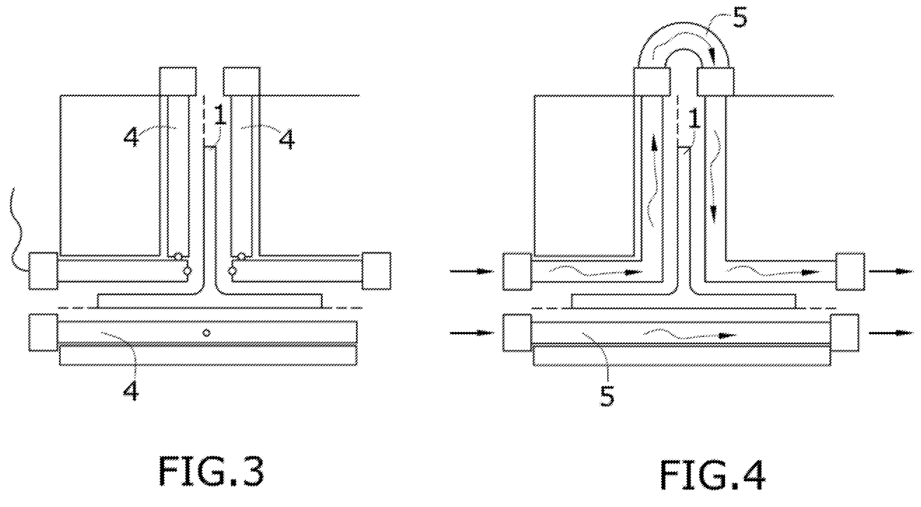

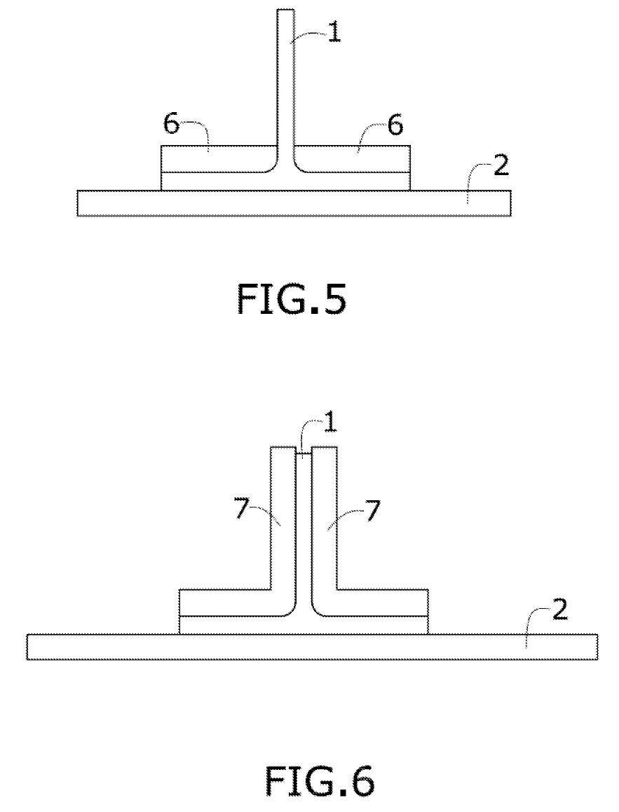

The temperature homogeneity and time control of the RTM process is important for achieving the specific degrees of cure required for the subsequent integration of the first (1) and second (2) part. To this end, the RTM mold (3) is equipped with a number of independent heat resistances (4) which allow a detailed control of the temperature of the first part (1). FIG. 3 shows a cross-section of an embodiment for the location of the heating system (4) into the RMT mold (3).

According to the disclosure herein, the epoxy resin exothermal reaction is stopped. In the shown embodiment it is stopped by re-circulating a cold fluid into the RTM mold (3) according to a specific cure cycle. Particularly, the recirculated cold fluid is water. Initial water cooling is carried out through specific holes machined on the mold (3). The glass transition temperature for this case is close to room temperature.

In an embodiment shown in the figures a partially cured stringer (1) is joined to a cured skin (2). The stringers (1) preforms are prepared by lay-up of layers with different orientations. The hot-forming of the layers involves a vacuum bag binding of the dry layers in furnace during 1 hour at 80° C. The hot-forming tool allows to prepare two L's and the capping parts necessary to assembly the stringer (1).

The stringers (1) preforms manufactured according to the procedure indicated in the previous paragraph are injected using a three-part RTM mold (3) as shown in FIG. 2. Two heating systems (web and flange) are mounted independently at different transversal sections in order to ensure a good temperature homogeneity of the RTM mold (3) during the stringer (1) curing cycle as it is shown in FIG. 3. Each heating resistance is instrumented with a K thermocouple to control the power delivered during time. A controlling unit is provided in order to control independently the resistances groups repeated through different cross sections of the RTM mold (3).

In an embodiment, all the inlet/outlet ports of the RTM mold (3) are closed and the temperature is raised up to 140° C. for the semicured stringer (1). The target temperature is close to 180° C. that represents the fully cured state. The targeted degree of cure is obtained by subjecting the stringer (1) to 140° C. during an specified time. The appropriate curing time was selected on different trials and errors combined with the degree of cure measurement through differential scanning calorimetry.

Provisions were also made for the water circulation at the three parts of the RTM mold (3). The heaters (4) and coolers (5) where not placed at the same cross section in order to distribute the heating and cooling loads uniformly over the length of the RTM mold (3).

A cure cycle for 50% and 75% of degree of cure was determined. The temperature variations between both tests were low and with negligible impact on the homogeneity of the degree of cure. This was demonstrated by mapping the glass transition temperature over the length and section of the stringers (1).

The RTM mold (3) cooling down from the curing temperature can be carried out in two stages. First, fluid at room temperature is conducted through the mold (3) until the temperature is decreased to, for instance, 20° C. (this temperature is enough to handle and open the mold (3)). The semicured stringer (1) is still in a deformable situation and simple demolding forces are enough to produce significant deformations. However, an additional temperature drop to, for instance, 0° C. is performed from 20° C. using for instance ethanol as cooling fluid. This last operation is done to ensure that the manipulation of the semicured stringer (1) is correct without any external deformation imposed by the operator. Moreover, the tackiness of the semicured resin at room temperature is high for handling and cooling down to, for instance, −5° C. helps in the manipulation of the material.

The over-cooling procedure facilitates the extraction of the semicured first part (1) from the mold (3). In the disclosed embodiment, the semicured stringers (1) were stored first in fridge at a temperature close to the target cooled temperature, for instance, at 2° C., to maintain the degree of cure and, when necessary, submitted to trimming and machining operations prior to the integration with the prepreg skins (2).

Trimming and machining operations in semicured materials could potentially be difficult due to the semicured state of the resin. Direct cutting with disk is not allowed as the semicured resin is not able to support fibers. The semicured resin is deformable and with the friction and heat generated during machining, the resin became softer allowing the fabric tows to move free inducing difficulties in the trimming by material blunting, ply delamination, etc. Therefore, specific trimming procedures are applied to reduce such difficulties delivering stringers (1) with a controlled final shape prior to the integration with prepreg skins (2). More specifically the laminate edges are clampled during trimming.

The prepreg skins (2) are prepared by lay-up with unidirectional prepreg in different orientations and with the aid of a flat steel plate used for lay up and curing. The steel plate was engraved in both sides with scribe lines to help during the lay-up and trimming operations. Four pins were inserted in the plates to serve as guides for caul plates (6, 7, 8) during the consolidation in the autoclave.

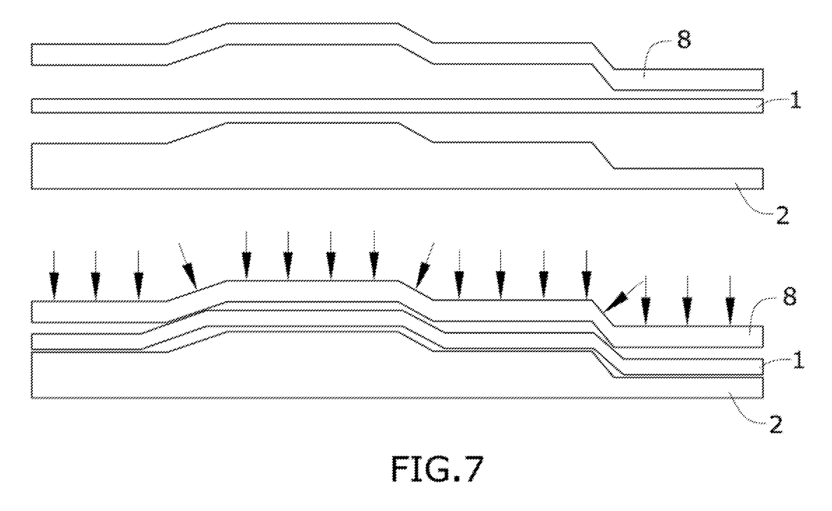

Angular (7) and plane (6) caul plates adapted to the shape of the stringer (1) are provided. Additionally, FIG. 7 shows a first part (1) in the form of a panel and a prepreg skin (2) being the caul plate (8) with the shape of the skin (2).

In all the cases, assembly of the first and second parts (1, 2) is performed in an autoclave and by inserting a structural adhesive between both parts (1, 2).

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing composite parts, wherein at least a first composite part is joined to a second composite part, the method comprising:
providing the first composite part preform into a resin transfer mold;
heating the first composite part into the resin transfer mold for performing a curing cycle of the first composite part;
cooling the first composite part before the curing cycle is completed so that a semi-cured first part is obtained; and
joining the semi-cured first part to a cured prepreg second part for obtaining a final composite part.

2. The method for manufacturing composite parts according to claim 1, wherein joining between the semi-cured first part and the cured prepreg second part is performed by inserting a structural adhesive between both parts.

3. The method for manufacturing composite parts according to claim 1, wherein joining between the semi-cured first part and the cured prepreg second part is performed in an autoclave.

4. The method for manufacturing composite parts according to claim 1, wherein joining between the semi-cured first part and the cured prepreg second part is performed by a mechanical press.

5. The method for manufacturing composite parts according to 1, wherein joining between the semi-cured first part and the cured prepreg second part is performed by pneumatics or hydraulics.

6. The method for manufacturing composite parts according to claim 1, wherein before providing the first composite part into the resin transfer mold the first composite part is hot formed.

7. The method for manufacturing composite parts according to claim 1, wherein the semi-cured first part is stored at a temperature close to the target cooled temperature to maintain a degree of cure prior to subsequent integration with the cured prepreg second part.

8. The method for manufacturing composite parts according to claim 1, wherein during cooling a fluid is recirculated into the mold.

9. The method for manufacturing composite parts according to claim 8, wherein the fluid is water.

10. The method for manufacturing composite parts according to claim 1, wherein cooling is performed in two stages, a first stage in which a first fluid is conducted through the mold until temperature is decreased at room temperature and a second stage having an additional drop of temperature.

11. The method for manufacturing composite parts according to claim 10, wherein the additional drop of the temperature is until −5° C.

12. The method for manufacturing composite parts according to claim 10, wherein the additional drop of the temperature is until 0° C.

13. A resin transfer mold for manufacturing composite parts that comprises a cavity for inserting a composite part preform and comprising a number of independent heat resistances and a cooling system that allow a control of the temperature of the composite part.

14. The resin transfer mold for manufacturing composite parts, according to claim 13, wherein the heat resistances and the cooling system are not placed at a same cross section of the mold in order to distribute the heating and cooling loads uniformly over a length of the mold.
